(19) United States
(12) Patent Application Publication
(10) Pub. No.: US 2009/0178827 A1
(43) Pub. Date: Jul. 16, 2009

(54) BI-MATERIAL RADIO FREQUENCY TRANSMISSION LINE AND THE ASSOCIATED MANUFACTURING METHOD

(75) Inventors: Erhard Mahlandt, Laatzen (DE); Gurgen Harutyunyan, Hannover (DE); Horst Fischer, Wunstorf (DE); Martin Greiner, Hemmingen (DE); Mark Davies, Braunschweig (DE); Ekkehard Schomburg, Burgwedel (DE)

Correspondence Address: FAY SHARPE/LUCENT, 1228 Euclid Avenue, 5th Floor, The Halle Building, Cleveland, OH, 44115-1843, US

(73) Assignee: Alcatel-Lucent via the Electronic Patent Assignment System (EPAS)

(21) Appl. No.: 12/332,184

(22) Filed: Dec. 10, 2008

Related U.S. Application Data
(60) Provisional application No. 61/013,005, filed on Dec. 12, 2007.

(30) Foreign Application Priority Data
Sep. 26, 2008 (EP) 08290909.4

(51) Int. Cl. H01B 5/00; B05D 5/12

(52) U.S. Cl. 174/126.1; 427/105

(57) ABSTRACT

The present invention relates to a bi-material radio frequency transmission line of cylindrical shape comprising a thin layer of highly conductive material supported by a base material wherein both materials are selected in function of the frequency of the transmitted signal and wherein the thickness of the thin layer is in a range from 1.2 to 2.4 times the depth of the skin effect at the frequency corresponding to the transmitted signal.

This application is based on and claims priority to U.S. Provisional Patent Application No. 61/013,005, filed Dec. 12, 2007, which is incorporated in its entirety herein by reference.

### BACKGROUND OF THE INVENTION

The present invention relates to the field of wire line or transmission line and more particularly of radio frequency (RF) transmission line.

RF transmission lines have to connect antennas with receivers and transmitters with a minimum of attenuation to provide a high efficiency of the system. Due to the attenuation of a transmission line, a part of the RF energy is converted to thermal energy. The attenuation is given by the dimension of a transmission line, the conductivity of the metal and the loss of the dielectric. At high frequencies the RF current doesn't flow through the whole layer but only a limited section due to the well known so called skin effect. Since normally highly conductive metals like copper or silver are much more expensive than metals with lower conductivity like aluminum or steel, bimetallic conductors are used for RF applications that have a comparably thin layer of highly conductive material.

An issue to address is the selection of a thickness of the highly conductive metal layer that is adjusted to provide an acceptable level of attenuation performance for a specified frequency band at minimal cost. In addition, a technology had to be identified that enables a simple adjustment of the highly conductive layer thickness in the manufacturing process of bimetallic conductors.

Well-known bimetallic components used in RF transmission lines are silver plated copper wires and copper clad aluminum wires for instance. Both are used as inner conductors in coaxial cable.

Existing solutions like copper clad aluminum wires for instance use a comparably thick layer of copper. Commercially available copper clad aluminum wires have a highly conductive copper layer of 10% to 15% of the total wire volume. This translates to a copper layer thickness of 0.13 to 0.19 mm for a typical wire of 4.8 mm diameter. This layer thickness results in a low attenuation as from comparably low frequencies. For typical RF applications in the frequency range as from 800 MHz for instance a copper layer thickness is sufficient that is one order smaller. Due to the manufacturing process of such copper clad aluminum wires the thickness can't be reduced to that level. Consequently, the amount of costly highly conductive metal is higher than necessary for the application.

Besides solid wires that are only used as inner conductors of coaxial cable, smooth or corrugated cylindrical tubes are used as conductors generally. They can be made as seamlessly drawn tubes or formed and welded from metal strips. The manufacturing process of bimetallic strips as described in EP-1 469 486 is limited in the variation of the highly conductive layer especially if the required thickness of the conductive layer is less than 10 μm.

### SUMMARY OF THE INVENTION

It is therefore an object of the present invention is to overcome the precited drawbacks of the state of the art and provide a method for determining the optimal thickness of highly conductive material and for manufacturing such layer. Moreover, the described solution will provide the advantage of a lower attenuation compared to existing RF conductors made from bimetals as well as pure highly conductive metals.

The present invention therefore refers to a bi-material radio frequency transmission line of cylindrical shape comprising a thin layer of highly conductive material supported by a base material wherein both materials are selected in function of the frequency of the transmitted signal and wherein the thickness of the thin layer is in a range from 1.2 to 2.4 times the depth of the skin effect at the frequency corresponding to the transmitted signal.

According to another embodiment, the base layer is a solid cylinder tube.

According to a further embodiment, the base layer is a hollow tube and wherein the thin layer of highly conductive material is plated on the outer face of said hollow tube.

According to an additional embodiment, the base layer is a hollow tube and wherein the thin layer of highly conductive material is plated on the inner face of said hollow tube.

According to another embodiment, the base layer surface in contact with the thin layer of highly conductive material is grooved.

According to a further embodiment, said thin layer of high conductive material is plated by an electron beam sputtering process.

According to an additional embodiment, the range of application of said transmission line is from 800 MHz to 2200 MHz.

According to a further embodiment the base material is a low conductive metal and the highly conductive material is a metal.

According to an additional embodiment, the highly conductive material is copper and the thickness of said thin layer of highly conductive material is equal to 1.6 times the skin depth.

According to another embodiment, said transmission line is composed of a copper coated aluminum and wherein the thickness of the thin layer of highly conductive material is in a range from 2 μm to 4 μm.

According to an additional embodiment, the base material is an insulator material.

It is also an object of the present invention to provide a method for manufacturing bi-material transmission lines comprising a base material and a thin layer of highly conductive material wherein the thickness of the thin layer corresponds to the depth of the skin effect at the frequency corresponding to the transmitted signal and wherein it comprises the following steps:
plating a thin layer of highly conductive material on one side of a flat strip of base material except on two edges of said flat strip,
forming a cylindrical tube by rolling said strip and welding the edges of said strip.

According to another embodiment of said method, the width of the unplated edges of said flat strip is determined such that, after the weld process the edges of the highly conductive material are in contact without any gap in between.

According to a further embodiment of said method, the step of forming a cylindrical tube is achieved such that the thin layer of highly conductive material is located on the inner side of said cylindrical tube.

### BRIEF DESCRIPTION OF THE DRAWINGS

FIG. 1 is a diagram representing a first embodiment of the present invention;

FIG. 2 is a diagram representing a second embodiment of the present invention;

FIG. 3 is a diagram representing a third embodiment of the present invention;

FIG. 4 is a diagram representing a intermediate step of the manufacturing method according to the present invention;

FIG. 5 is a graph representing the relative resistance of three different bimetallic conductors in function of the plating thickness;

FIG. 6 is a graph representing losses of different conductor types in function of the frequency;

FIG. 7 is a graph representing the difference of attenuation for cables having different high conductive layer thicknesses in function of the frequency;

### DETAILED DESCRIPTION OF THE INVENTION

As used herein, the term “coaxial cable” refers to an inner conductor covered by an insulating spacer, covered by an outer conductor.

As used herein, the term “waveguides” refers to a high conductive material covered by a low conductive material.

The invention can be used in all transmission lines that are used for high frequency applications (from 100 MHz to 10 GHz). This can be coaxial cables but also waveguides.

The invention describes conductors for RF transmission lines made of bimetal conductors having a metal base layer of comparable large thickness with relatively low conductivity with a thin second layer of a highly conductive metal. The construction of the RF transmission lines is such that the highly conductive layer of the conductors is oriented towards the RF field. In case of a coaxial cable the highly conductive layer of the inner conductor is placed on the outside while it is placed on the inside for an outer conductor.

The thickness is selected as to achieve a lower attenuation compared to existing bimetallic and solid conductors.

A manufacturing process that is able to produce easily adjustable conductive layers at a thickness of several μm is the electron beam sputtering process. This process can be used for plating of substrates in the shape of wire, tube as well as flat strip. The electron beam sputtering process also enables the production of flat strips with unplated longitudinal edges that would be required to form and weld a cylindrical tube.

FIG. 1 describes a bimetallic wire with a low conductive core 1 and a highly conductive outer layer 2.

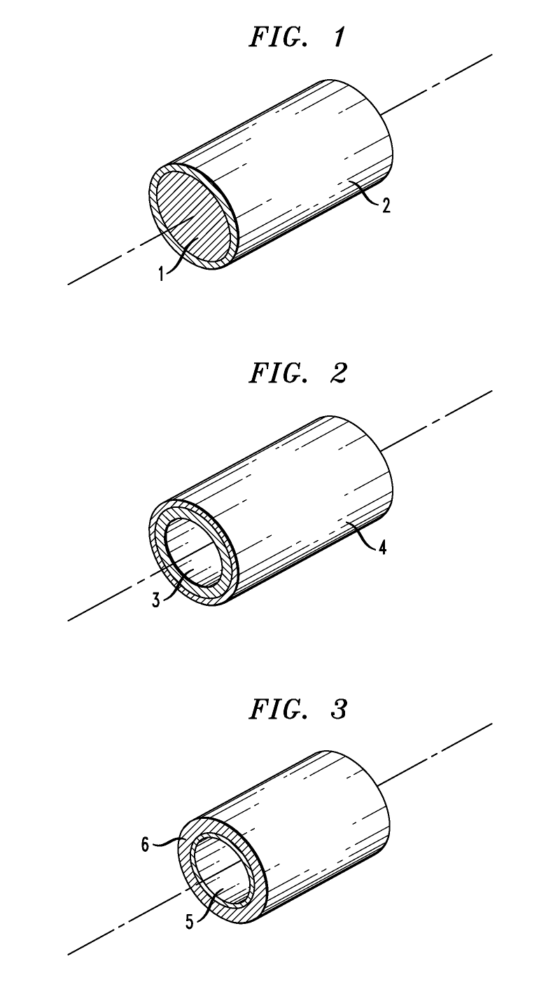

FIG. 2 shows a tube with a low conductive base 3 that is plated with a thin highly conductive layer 4.

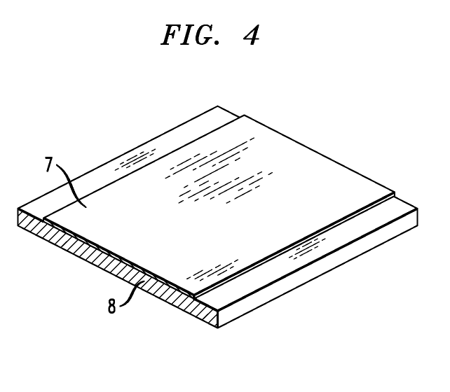

FIG. 3 shows a tube that is made with the thin highly conductive material from the inside 5 of the low conductive base 6.

FIG. 4 shows a flat strip 8 with partly plated highly conductive material 7. The manufacturing of tubes from flat strips is made such that the strip is formed to a tube and welded longitudinally at the parallel edges. To avoid a mix of materials at the weld seam there should only be a single type of metal. Therefore, the edges of the strip are unplated. The width of the unplated edges can be selected such that after the weld process the edges of the highly conductive materials are in contact without any gap in between.

The inner and outer surfaces of the tube can also be grooved if it is required by the manufacturing process.

The attenuation of a coaxial cable increases with increasing frequency. For a cable with single metal conductors the attenuation at RF frequencies can be described with the formula

a(f)=aᵣ*\sqrt{f}+a_{g}*f [1]

with a(f) the attenuation, aᵣ the coefficient given by the conductors, a_{g} the coefficient given by the dielectric and f the frequency.

Having a bimetallic conductor with a frequency specific thickness the coefficient aᵣ becomes a function of the frequency.

The attenuation coefficient aᵣ is caused by the losses of the inner conductor a_{IC} and outer conductor a_{OC}. The attenuation of a coaxial cable utilizing the same material for both conductors is calculated as follows:

$${a}_{r} = {a}_{IC} + {a}_{OC} = \frac{8 , 686}{( 2 * π * {Z}_{0} )} * {Z}_{C} * ( \frac{{k}_{IC}}{{r}_{IC}} + \frac{{k}_{OC}}{{r}_{OC}} ) \qquad [ 2 ]$$

with r_{IC} the outer radius of inner conductor, r_{OC} the inner radius of outer conductor, k_{IC} the corrugation coefficient of the inner conductor, k_{OC} the corrugation coefficient of the outer, Z₀ the characteristic impedance of the conductors and Zc the impedance of the conductors which is described as:

$${Z}_{c} = \sqrt{\frac{( jωμ )}{σ}} = ( 1 + j ) * \sqrt{\frac{( πμ f )}{σ}} \qquad [ 3 ]$$

with σ,μ the conductivity and permeability of conductor, j the imaginary unit and w the angular frequency (w=2πf).

For bimetallic conductors we calculate the characteristic impedance by

$${Z}_{Bim} = ( \frac{{γ}_{1}}{{σ}_{1}} ) * ( \frac{( sinh ( {γ}_{1} d ) + \frac{( {γ}_{2} * {σ}_{1} )}{( {γ}_{1} * {σ}_{2} )} * cosh ( {γ}_{1} d ) )}{( cosh ( {γ}_{1} d ) + \frac{( {γ}_{2} * {σ}_{1} )}{( {γ}_{1} * {σ}_{2} )} * sinh ( {γ}_{1} d ) )} ) \qquad [ 4 ]$$

with σ₁ and σ₂ the conductivities of the plating and the base metals, γ₁ and γ₂ the propagation functions of the plating and the base metals which are defined as:

γ_{c}=\sqrt{(πμσf)}*(1+j) [5]

After modification of [4] by using of [3] and [5] we get a simplified form of the characteristic impedances for bimetallic conductor:

$${Z}_{Bim} = {Z}_{1} * ( \frac{( sinh ( {γ}_{1} d ) + \frac{{Z}_{2}}{{Z}_{1}} * cosh ( {γ}_{1} d ) )}{( cosh ( {γ}_{1} d ) + \frac{{Z}_{2}}{{Z}_{1}} * sinh ( {γ}_{1} d ) )} ) \qquad [ 6 ]$$

We can use the equation [5] for cylindrical conductors in case of r_{c}>>dlow>>δ (with δ being the skin depth). By using of the equation [2] and [5] we calculate the conductor losses aᵣ for coaxial cable.

Due to the thin coating of a highly conductive material on low conductive base material we take the advantage of the phenomenon of a reduced resistance known for thin wall metallic pipes.

At high frequencies, current density and phase depend on the skin depth. At the skin depth δ the current density is 1/e (where e is the Euler constant) times the current density at the surface and has a phase shift of 57.3°. By dₜ=1,6 δ (dₜ is the wall thickness of a tube) the resistance of a thin wall tube is about 10% lower as solid conductor. This effect happens due to an opposite phase (destructive) of the current part inside a solid conductor. The same effect occurs in bimetallic conductors. The amount of destructive current is lower because of the lower conductivity of the base material.

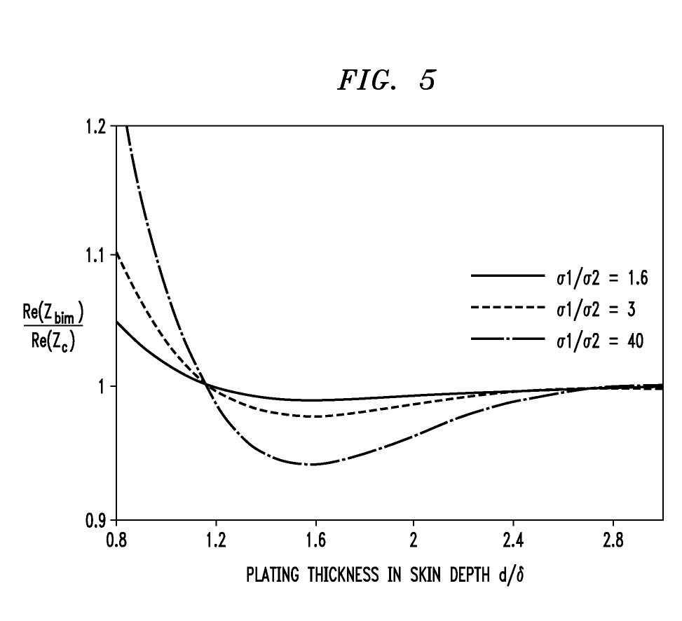

FIG. 5 represents the calculated relative resistance described as the ratio of effective resistance of bimetallic conductor (equation [6]) to a copper conductor (equation [3]) for three bimetals with different conductivity ratios (σ₁/σ₂).

FIG. 5 shows the described reduced resistance at d_{c}=1.6 δ (d_{c} is the thickness of coating) and more generally in a span from 1.2δ to 2.4δ. It also shows that the resistance will reduce even more with the reduction of the conductivity of the base material σ2.

From the investigation of this effect of reduced resistance we conclude that for cable with bimetallic conductors it is better to use a base material with a minimum conductivity. This will provide more flexibility by choosing an appropriate base material focusing more on mechanical properties and cost rather than on conductivity.

The frequency-tuned thickness of highly conductive material reduces the amount of highly conductive expensive material to a minimum. While at the same time the electrical performance is controlled for the specific frequency band in terms of attenuation which is reduced to a minimum, that is less than the attenuation of existing solutions. The process of electron beam sputtering enables a simple application of the required thickness of highly conductive layer and provides a smooth surface. The appropriate thickness helps to reduce the attenuation at specified frequencies and also partly flattens the attenuation frequency response of a coaxial cable.

A bimetallic conductor with the disclosed thin thickness of highly conductive metal provides a cost efficient solution with better transmission performance than existing solutions, be it bimetal conductors with comparably thick layer of highly conductive material or solid conductors.

The reduced attenuation of feeder cables in antenna systems provides better signal quality in antenna systems since more power is available on the antenna and verse visa at the receiver. It can be a cost advantage in transmission systems since in certain situations a smaller size and therefore cheaper cable can be used.

With an example, we demonstrate the advantage of this invention. The attenuation of a ⅞″ cable with copper clad aluminum bimetallic inner and outer conductors is calculated and compared to cables made with aluminum and copper conductors.

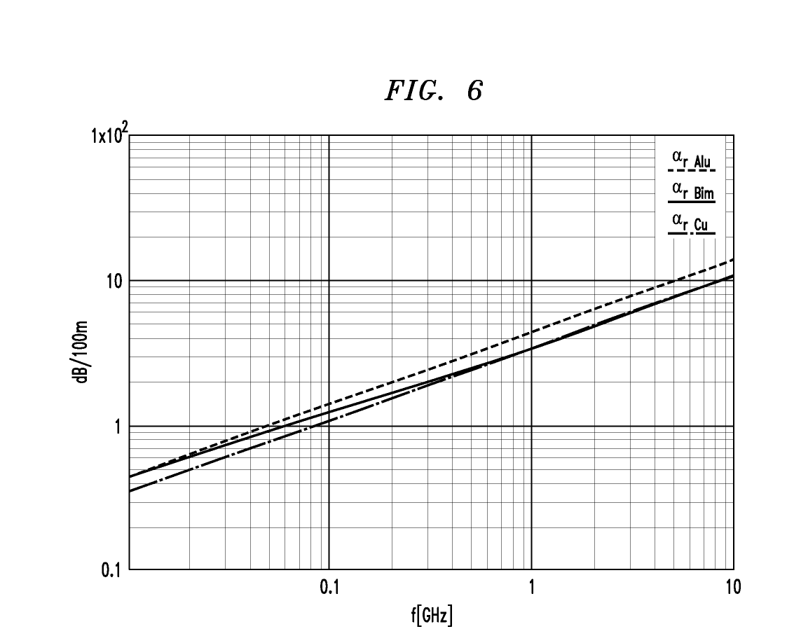

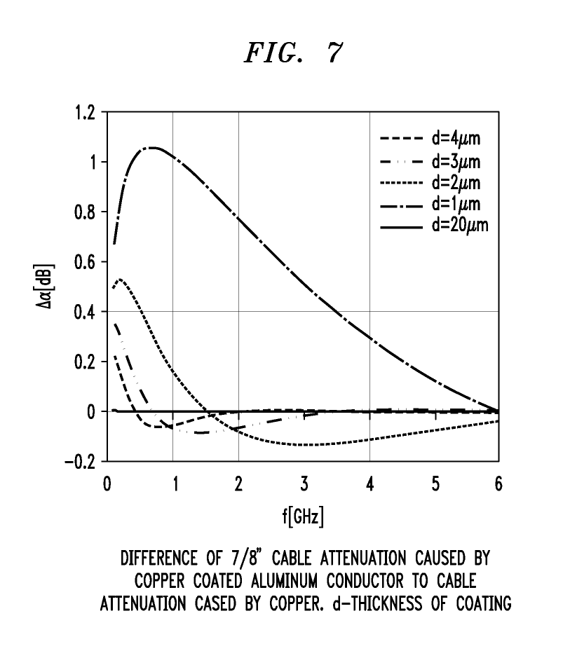

FIG. 6 represents the cable attenuation (in dB per 100 m) caused by conductors mode of copper, aluminum and 3 μm copper coated aluminum.

The solid line is the attenuation of the cable with bimetal inner and outer conductors. At frequencies lower than 600 MHz it has the characteristic of an aluminum cable (dashed line) while at higher frequencies it has the electrical performance similar to a copper cable (dotted line).

The advantage described in this invention compared to existing bimetallic solution can't be seen in the logarithmic scale in FIG. 6 but will become obvious in FIG. 7. It shows the difference of conductor losses of a typical ⅞″ cable made with copper clad aluminum (AlCu) conductors of different copper thicknesses in comparison to solid copper conductors.

As FIG. 7 shows, a cable mode with copper clad aluminum conductors with a copper thickness of 20 μm there is actually no attenuation improvement compared to a cable made of pure copper conductors. The curve is almost a straight line at the level of zero.

If the copper layer thickness is 1 μm and below there is an attenuation increase at frequencies below 6 GHz.

Only if the copper layer thickness is in the range of 2 μm to 4 μm there is a significant attenuation improvement in the frequency range of mobile communication Systems (800 MHz to 2200 MHz).

The desired layer thickness will be different for other substrates than aluminum and other highly conductive layers than copper.

A cable made with AlCu conductors having a copper layer thickness of 20 μm that is the smallest thickness currently observed in the market provides an insignificant lower attenuation in a frequency band below 900 MHz. The copper layer thickness of 2 to 4 μm that we propose in our invention for AlCu conductors reduces the attenuation in the range of 0.05 to 0.15 dB/100 m in the frequency band of mobile communication which is a main application for coaxial cable that is critical in terms of attenuation.

The thickness of the highly conductive layer needs to be selected according to the desired frequency band of the application.

The effect can even be improved if aluminum is not selected as base material but a metal with less conductivity like steel for instance. The desired performance would be achieved with an insulator material like plastic.

Electron beam sputtering is the most suitable process for making the described thickness of thin and smooth metal layers. The behavior of existing solution with 20 μm coating is similar to copper cable at frequencies used in mobile communication and have higher attenuation as our solution.

Thus, the present invention allows to reduce signal attenuations along a transmission line and to reduce the manufacturing cost of said transmission line thanks to the use of an electron beam sputtering process allowing to decrease the thickness of the highly conductive layer and the use of very low or even non conductive material as base material.

1. Bi-material radio frequency transmission line of cylindrical shape comprising a thin layer of highly conductive material supported by a base material wherein both materials are selected in function of the frequency of the transmitted signal and wherein the thickness of the thin layer is in a range from 1.2 to 2.4 times the depth of the skin effect at the frequency corresponding to the transmitted signal.

2. Bi-material radio frequency transmission line in accordance with claim 1 wherein the base layer is a solid cylinder tube.

3. Bi-material radio frequency transmission line in accordance with claim 1 wherein the base layer is a hollow tube and wherein the thin layer of highly conductive material is plated on the outer face of said hollow tube.

4. Bi-material radio frequency transmission line in accordance with claim 1 wherein the base layer is a hollow tube and wherein the thin layer of highly conductive material is plated on the inner face of said hollow tube.

5. Bi-material radio frequency transmission line in accordance with claim 2 wherein the base layer surface in contact with the thin layer of highly conductive material is grooved.

6. Bi-material radio frequency transmission line in accordance with claim 1 wherein said thin layer of high conductive material is plated by an electron beam sputtering process.

7. Bi-material radio frequency transmission line in accordance with claim 1 wherein the range of application of said transmission line is from 800 MHz to 2200 MHz.

8. Bi-material radio frequency transmission line in accordance with claim 1 wherein the base material is a low conductive metal and the highly conductive material is a metal.

9. Bi-material radio frequency transmission line in accordance with claim 8 wherein the highly conductive material is copper and the thickness of said thin layer of highly conductive material is equal to 1.6 times the skin depth.

10. Bi-material radio frequency transmission line in accordance with claim 1 wherein said transmission line is composed of a copper coated aluminum and wherein the thickness of the thin layer of highly conductive material is in a range from 2 μm to 4 μm.

11. Bi-material radio frequency transmission line in accordance with claim 1 wherein the base material is an insulator material.

12. Method for manufacturing bi-material transmission lines comprising a base material and a thin layer of highly conductive material wherein the thickness of the thin layer corresponds to the depth of the skin effect at the frequency corresponding to the transmitted signal and wherein it comprises the following steps:
plating a thin layer of highly conductive material on one side of a flat strip of base material except on two edges of said flat strip,
forming a cylindrical tube by rolling said strip and welding the edges of said strip.

13. Method for manufacturing bi-material transmission lines in accordance with claim 12 wherein the width of the unplated edges of said flat strip is determined such that, after the weld process, the edges of the highly conductive material are in contact without any gap in between.

14. Method for manufacturing bi-material transmission lines in accordance with claim 12 therein the step of forming a cylindrical tube is achieved such that the thin layer of highly conductive material is located on the inner side of said cylindrical tube.
